(19) United States
(12) Patent Application Publication
(10) Pub. No.: US 2024/0330838 A1
(43) Pub. Date: Oct. 3, 2024

(54) Method and System for Analyzing Transport Capacity of Container Liner Routes

(71) Applicants: Shanghai Ship & Shipping Research Institute Co., Ltd., Shanghai (CN); COSCO SHIPPING TECHNOLOGY CO., LTD., Shanghai (CN)

(72) Inventors: Zhexi ZHANG, Shanghai (CN); Lin ZHU, Shanghai (CN)

(21) Appl. No.: 18/692,737

(22) PCT Filed: Sep. 18, 2021
(86) PCT No.: PCT/CN2021/119416

§ 371 Date: Mar. 15, 2024

(30) Foreign Application Priority Data
Sep. 16, 2021 (CN) 202111086241.9

(51) Int. Cl. G06Q 10/0831; G06Q 10/047

(52) U.S. Cl. CPC G06Q 10/0831; G06Q 10/047

(57) ABSTRACT

The present invention provides a method and system for analyzing transport capacity of container liner routes. The method comprises: firstly, collecting and pre-processing AIS historical navigation data and port data of container liners; then realizing identification of global container liner routes by using a depth-first search algorithm in combination with characteristics of AIS data and actual service features of the container liners; then performing deduplication and time information matching on the identified routes in combination with service logic, extracting information of countries and regions through which the route passes, start and end time of the route, operation entity of the route, direction of the route and ports of the start and end of the route, and classifying the routes; finally, according to classified routes, carrying out transport capacity statistics and transport capacity change analysis of container liner routes passing through any two ports, thereby providing support for the transport capacity planning based on big data, defining a unified standard for all container liner routes, and providing a data basis for the comparison of operating efficiency of various shipping companies and providing data support for development of new routes.

### TECHNICAL FIELD

The present invention relates to a technical field of container shipping, in particular to a method and system for analyzing transport capacity of container liner routes.

### BACKGROUND TECHNIQUE

Against the backdrop of increasingly important and close international trade, due to advantages of fast shipping speed and high loading and unloading efficiency, containers have become an important component of global maritime international trade. According to the “2019 Global Maritime Development Review Report” released by the United Nations Conference on Trade and Development (UNCTAD), it can be seen that volume of cargo transported by containers is increasing year by year.

A container liner route is a route in which containerized cargo is carried between at least two ports by container ships that regularly travel to and from or around them. It is characterized by the use of containers for liner transport. At present, most container lines are operated in the form of liners. Since container liner routes are defined by different shipping companies, there is no uniform standard for container liner routes. As a result, these variously defined standards create obstacles to monitoring of transport capacity on global container liner routes. At present, a main method to solve this problem is to monitor the transport capacity by collecting shipping schedules of various large-scale shipping companies and relevant ship type information of container ships. But this method consumes manpower and resources. In addition, the shipping schedules may be inaccurate or incomplete, so it is difficult to ensure data quality, thus affecting analysis of the transport capacity.

### SUMMARY OF THE INVENTION

In order to solve problems that collecting shipping schedule and ship type information to monitor transport capacity will consume manpower and material resources and it is difficult to guarantee data quality due to the lack of unified definition standard of container liner routes, the present invention provides a method for analyzing transport capacity of the container liner routes. Based on algorithms related to graph theory, this method uses AIS dynamic data of container ships and their service logic to identify global container liner routes, and sorts out relevant information of the routes according to ports through which the routes pass, so as to monitor the transport capacity of global container routes. The present invention also relates to a system for analyzing the transport capacity of container liner routes.

The technical solution of the present invention is as follows:

A method for analyzing transport capacity of container liner routes, comprising following steps:
a data collection step: collecting AIS historical navigation data and port data of container liners;
a route identification step: based on collected data, by taking ports as nodes and container liner's shipping segments between ports as edges, drawing a directed graph of the liner's shipping route between or among ports for a single container liner; searching for all loops in the directed graph by using a depth-first search algorithm to identify the container liner routes;
a route processing step: matching the loops with the historical navigation data so that only the loops that can be matched are retained, finding departure time and end time of each route, removing data with overlapping times, and then finding similar routes that appear at least twice in succession and saving the routes as identified routes;
a route information extraction and classification step: removing duplication of found route results, extracting, according to information of the ports through which the route passes, information of countries and regions through which the route passes, start and end time of the route, operation entity of the route, direction of the route and ports of the start and end of the route, and classifying the routes;
a route transport capacity analysis step: according to classified routes, carrying out transport capacity statistics and transport capacity change analysis of container ship routes passing through any two ports to obtain results of the transport capacity statistics and transport capacity change analysis of the routes, thus providing data basis for comparison of operating efficiency of various shipping companies and data support for development of new routes.

Preferably, wherein the data collection step, the AIS historical navigation data includes static data and dynamic data, the static data includes Maritime Mobile Service Identify, ship type, call sign, ship name, ship height, ship length and ship width, the dynamic data includes ship longitude and latitude position information, time stamp, course over ground, speed over ground and bow direction.

Preferably, wherein the data collection step, the port data includes start and end times of each shipping segment and the ports of origin and end, the countries and regions to which the ports belong, and the longitudes and latitudes of the ports.

Preferably, wherein the data collection step, first of all, pre-processing the AIS historical navigation data to remove problematic data in the AIS, and then pre-processing the port data to remove data related to ship repair, data where the port of origin and port of destination are missing, data related to unknown ports, and data where the port of origin and port of destination are the same, matching the ports of origin and ports of destination to corresponding countries and regions respectively.

Preferably, wherein the route identification step, the depth-first search algorithm is adopted to carry out depth-first search with each port as starting point, duplicate paths in search results are removed, and then all loops in the directed graph are found.

Preferably, wherein the route processing step, using Jaccard similarity coefficient to calculate similarity between two routes, and then the similar routes are determined.

Preferably, wherein the route processing step, according to the historical navigation data of container liners, the parts that do not form loops are found by combining service logic, these parts, together with matched loops, are sorted according to the departure time and end time of each route to ensure integrity of historical navigation dynamics.

Preferably, wherein the route information extraction and classification step, a Haversine formula is adopted to first calculate a distance between the ports through which the route passes in two relative directions, and then determines the direction of the route.

A system for analyzing transport capacity of container liner routes, comprising a data collection module, a route identification module, a route processing module, a route information extraction and classification module and a route transport capacity analysis module,
the data collection module is used for collecting AIS historical navigation data and port data of container liners;
the route identification module is used for, based on collected data, by taking ports as nodes and container liner's shipping segments between ports as edges, drawing a directed graph of the liner's shipping route between or among ports for a single container liner; searching for all loops in the directed graph by using a depth-first search algorithm to identify circular container liner routes;
the route processing module is used for matching the loops with the historical navigation data so that only the loops that can be matched are retained, finding departure time and end time of each route, removing data with overlapping times, and then finding similar routes that appear at least twice in succession and saving the routes as identified routes;
the route information extraction and classification module is used for removing duplication of found route results, for extracting information of countries and regions through which the route passes, start and end time of the route, operation entity of the route, direction of the route and ports of the start and end of the route according to information of the ports through which the route passes, and for classifying the routes;
the route transport capacity analysis module is used for, according to classified routes, carrying out transport capacity statistics and transport capacity change analysis of container ship routes passing through any two ports to obtain results of the transport capacity statistics and transport capacity change analysis of the routes, thus providing data basis for comparison of operating efficiency of various shipping companies and data support for development of new routes.

Preferably, the AIS historical navigation data includes static data and dynamic data, the static data includes Maritime Mobile Service Identify, ship type, call sign, ship name, ship height, ship length and ship width, the dynamic data includes ship longitude and latitude position information, time stamp, course over ground, speed over ground and bow direction; the port data includes start and end times of each shipping segment and the ports of origin and end, the countries and regions to which the ports belong, and the longitudes and latitudes of the ports;
and/or, wherein the route identification module, the depth-first search algorithm is adopted to carry out depth-first search with each port as starting point, duplicate paths in search results are removed, and then all loops in the directed graph are found.

The beneficial effects of the present invention are as follows:

The present invention provides a method for analyzing transport capacity of container liner routes, which sequentially set up a data collection step, a route identification step, a route processing step, a route information extraction and classification step and a route transport capacity analysis step, and the steps cooperate and work together. Firstly, AIS historical navigation data and port data of container ships are collected and pre-processed, collected data are all real navigation data in the history of container liners, thus ensuring authenticity and accuracy of identified routes; after data collection and further preprocessing, by taking ports as nodes and container ship's shipping segments between ports as edges, a directed graph of the ship's shipping route between or among ports for a single container ship is described, and all loops in the directed graph are found out by using the Depth First Search (DFS) algorithm to identify the container ship routes; the loops are then matched with the historical navigation data, the loops that match actual course of the navigation will be kept, and the departure time and end time of each route will be found, data including loops that overlap in time will be removed to ensure that the loops found do not have duplicates in time, and then the similar routes that appear at least twice in succession are identified and saved as confirmed routes; the duplication of the found route results is removed by removing the routes passing through the same ports but in different order, to avoid a problem of repeated routes found due to different sequences of ports in the DFS loop finding process, the information of the countries and regions through which the route passes, the start and end time of the route, the operation entity of the route, the direction of the route and the port of the start and end of the route is extracted according to the information of the ports through which the route passes, and the routes are classified according to major global container liner routes; finally, according to the classified routes, the container ship routes passing through any two ports are analyzed in terms of transport capacity statistics and transport capacity changes, so as to retain information of operating shipping companies of each route, provide data basis for the comparison of the operating efficiency of various shipping companies, and provide data support for the development of new routes. This method identifies global container liner routes by using AIS historical navigation dynamic data of container ships and combining service logic, according to the ports through which the route passes, the relevant information of the route is sorted out, and then the transport capacity of the global container route is monitored. A unified standard has been defined for all container liner routes. It also provides support for the transport capacity statistics and monitoring of sub-routes. At the same time, the ship type information of each route is retained, which is convenient for follow-up dynamic query of the route, transport capacity and ship type between any two ports.

The invention also relates to the system for analyzing transport capacity of container liner routes. The system corresponds to the method for analyzing the transport capacity of container liner routes mentioned above, and can be understood as the system to realize above method. The system comprises successively connected the data collection module, the route identification module, the route processing module, the route information extraction and classification module and the route transport capacity analysis module which cooperate and work together. By using the depth-first search algorithm, combined with the AIS historical navigation data of container ships and actual business characteristics of container liners, the system completes the identification and naming of global container liner routes, and then analyzes the transport capacity to provide support for the transport capacity planning based on big data.

### BRIEF DESCRIPTION OF THE DRAWINGS

FIG. 1 is a flowchart of the method for analyzing transport capacity of container liner routes according to the invention.

FIG. 2 is a preferred flowchart of the method for analyzing transport capacity of container liner routes according to the invention.

FIG. 3 is a reference diagram of the shipping routes that define start and end of the routes.

### DETAILED DESCRIPTION OF THE INVENTION

The present invention will be described below with reference to accompanying drawings.

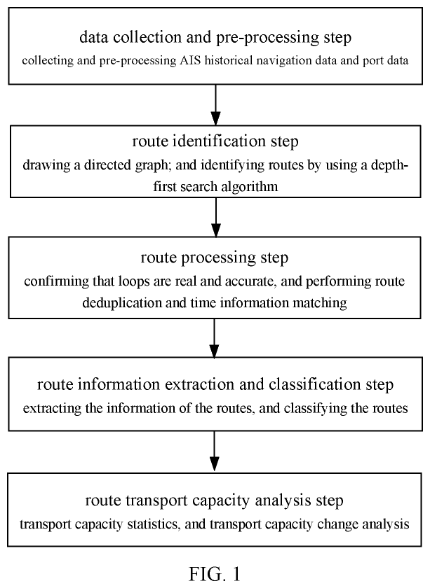

The invention relates to the method for analyzing transport capacity of container liner routes. The flowchart of this method is shown in FIG. 1, which comprises following steps in turn:

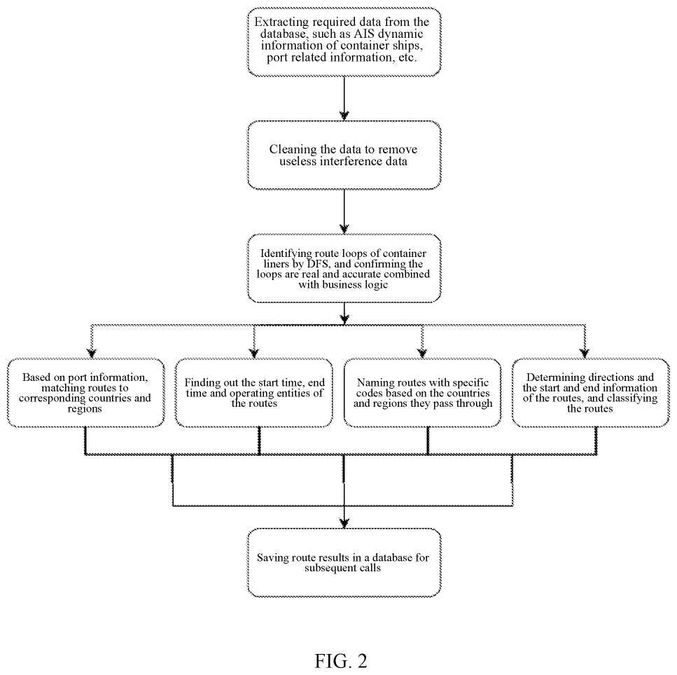

The data collection step, or further referred to as data collection and preprocessing step: collecting and pre-processing AIS historical navigation data and port data of container ships. Specifically, in the preferred flowchart shown in FIG. 2, a MySQL database is accessed by using psycopg2 in Python language, which is the PostgreSQL database interface to the Python language. The AIS historical navigation data and port data of the container ship with Maritime Mobile Service Identify (MMSI) 477776200 were extracted from the MySQL database. After obtaining above data, the data is cleaned to remove useless data that causes interference. First of all, the AIS data is preprocessed to remove problematic data (such as data with too many defects) in the AIS. The port data is then preprocessed to remove data related to ship repair, data where the port of origin and port of destination are missing, data related to unknown ports, and data where the port of origin and port of destination are the same. Finally, the ports of origin and ports of destination are matched to respective countries and regions. Preferably, the AIS historical navigation data includes static data and dynamic data. The static data includes Maritime Mobile Service Identify (MMSI), ship type, call sign, ship name, ship height, ship length and ship width, etc. The dynamic data includes ship longitude and latitude position information, time stamp, course over ground, speed over ground and bow direction, etc. Preferably, the port data includes start and end times of each segment, as well as the ports of origin and destination, the countries and regions to which the ports belong, and the longitudes and latitudes of the ports.

It should be noted that above regions refer to the division of the world's geographical regions by the United Nations, which is a set of world regional classification schemes designed by the United Nations Statistics Division based on M49 classification codes. This set of world regional classification schemes is mainly based on the “United Nations geographical programme” (also translated as “United Nations map”) or “United Nations geographical divisions”.

The route identification step: based on the pre-processed data, according to characteristics of container liner's regular round-trip between or circumnavigation among ports, referring to definitions of nodes and edges in graph theory, by taking ports as nodes and container liner's shipping segments between ports as edges, a directed graph of the liner's shipping route between or among ports is drawn for a single container liner. A depth-first search algorithm is used to find all loops in the directed graph. The results of the loops finding are shown in Table 1. Table 1 shows the DFS loop finding results for a container ship with MMSI of 477776200 (only first 10 results are shown here) to identify the container liner's route.

TABLE 1
[ [symbol] Long Beach Oakland Tianjin Qingdao Shanghaj-Yangshan Nansha Singapore
Cai Mep China Hong Kong Yantian China Taiwan-Kaohsiung Long Beach [symbol] , [symbol]
China Hong Kong Shanghai-Yangshan Prince Rupert Long Beach China Taiwan-Kaohsiung Cai Mep Nansha Yantian China Hong Kong [symbol] , [symbol]
Qingdao Shanghai-Yangshan Nansha Yantian China Hong Kong China Taiwan-Kaohsiung Long Beach Oakland Tianjin Qingdao [symbol] , [symbol]
China Taiwan-Kaohsiung Cai Mep Nansha China Hong Kong Yantian Shanghai-Yangshan Long Beach China Taiwan-Kaohsiung [symbol] , [symbol]
China Taiwan-Kaohsiung China Hong Kong Shanghai-Yangshan Nansha China Taiwan-Kaohsiung [symbol] , [symbol]
China Taiwan-Kaohsiung Cai Mep China Hong Kong Yantian Shanghai-Yangshan Long Beach China Taiwan-Kaohsiung [symbol] , [symbol]
Singapore Cai Mep China Hong Kong Shanghai-Yangshan Ningbo Nansha Singapore [symbol] , [symbol]
Yantian China Taiwan-Kaohsiung Cai Mep Nansha China Hong Kong Yantian [symbol] , [symbol]
Tianjin Qingdao Shanghai-Yangshan Ningbo Nansha China Taiwan-Kaohsiung Long Beach Oakland Tianjin [symbol] , [symbol]
Prince Rupert Long Beach China Taiwan-Kaohsiung Cai Mep China Hong Kong Shanghai-Yangshan Prince Rupert [symbol] ] [symbol]
indicates data missing or illegible when filed

It should be noted that one of rows in Table 1 above is the result of a loop finding for a route. The top 10 results are shown in Table 1.

The Depth First Search (DFS) is an algorithm used to traverse or search a tree or graph. The algorithm traverses the node v of the tree along the depth of the tree to search branches of the tree as deep as possible. When all edges of the node v have been explored or a node does not meet criteria during the search, the search will be traced back to starting node of the edge where the node v was found. The whole process repeats until all nodes are accessed. DFS can be used to determine whether there is a loop in a directed graph. Depth-first traversal is performed on the directed graph. If, during the traversal, one of the edges of a node is found to point to another node that has already been accessed, there is a loop. The result of this algorithm is related to the starting point of depth-first search, and different starting points may cause different results.

It can be understood that since the results of DFS loop finding are related to the starting point of the search, in order to find all loops in the directed graph, the depth-first search needs to be performed from each port as the starting point to remove duplicate paths in the search results, so as to ensure that the search results of loop finding are not duplicated and missed.

The route processing step: due to DFS only finds loops in the directed graph from a mathematical perspective, there may be loops that are mathematically valid but not actually navigable by ships. Therefore, it is necessary to combine actual business logic to confirm whether the found loop is true and accurate. The loops found through DFS are matched with the ship's historical navigation data so that only the loops that can be matched are retained. This suggests that these loops were real during the navigation process of the ship. The departure and end times of each route are then found. Data with overlapping times are removed to ensure that the loops found will not be duplicated in time. Then, according to the historical navigation data of container ships, the parts that do not form loops are found. These parts, together with the matched loops above, are sorted according to the departure time and end time of each route to ensure integrity of historical navigation dynamics and facilitate subsequent route transport capacity monitoring. Then the similar routes that appear at least twice in succession are found and saved as the identified routes. Finally, the missing navigation segments will be filled in. The results after being filled in are shown in Table 2, which shows the route processing results of the container ship with MMSI of 477776200. (Only the top 10 results are shown here)

TABLE 2

| | | departure | | |
|---|---|---|---|---|
| | | dates by | start | end |
| | route ports | ports | time | time |
| 0 | Singapore Jebel Ali Khalifa Dammam Singapore | [symbol] | 2019 Jan. 20 | 2019 Feb. 14 |
| 1 | Singapore Cai Mep China Hong Kong Yantian Shanghai-Yangshan | [symbol] | 2019 Feb. 14 | 2019 Feb. 2 [symbol] |
| 2 | Shanghai-Yangshan Qingdao Shanghai-Yangshan | [symbol] | 2019 Feb. 2 [symbol] | 2019 Mar. 20 |
| 3 | Shanghai-Yangshan Ningbo Prince Rupert Los Angeles | [symbol] | 2019 Mar. 20 | 2019 May 11 |
| | Oakland Tianjin Qingdao Shanghai-Yangshan | | | |
| 4 | Shanghai-Yangshan Prince Rupert Long Beach | [symbol] | 2019 May 11 | 2019 Jun. 29 |
| | Oakland Tianjin Qingdao Shanghai-Yangshan | | | |
| 5 | Shanghai-Yangshan Prince Rupert Los Angeles | [symbol] | 2019 Jun. 29 | 2019 Aug. 18 |
| | Tianjin Qingdao Shanghai-Yangshan | | | |
| 6 | Shanghai-Yangshan Prince Rupert Los Angeles | [symbol] | 2019 Aug. 18 | 2019 Oct. 7 |
| | Oakland Tianjin Qingdao Shanghai-Yangshan | | | |
| 7 | Shanghai-Yangshan Prince Rupert Los Angeles | [symbol] | 2019 Oct. 7 | 2019 Nov. 23 |
| | Oakland Tianjin Qingdao Shanghai-Yangshan | | | |
| 8 | Shanghai-Yangshan Prince Rupert Los Angeles | [symbol] | 2019 Nov. 23 | 2020 Jan. 12 |
| | Oakland Tianjin Qingdao Shanghai-Yangshan | | | |
| 9 | Shanghai-Yangshan Prince Rupert Los Angeles | [symbol] | 2020 Jan. 12 | 2020 Feb. 27 |
| | Oakland Tianjin Qingdao Shanghai-Yangshan | | | |

[symbol]

indicates data missing or illegible when filed

It can be seen that the shipping routes operated by the container ship in 2019-2020 are ports in North and East China to ports in the United States and Canada on west coast of North America.

It should be noted that the Jaccard coefficient is used to judge whether the routes are similar here. This coefficient is used to compare similarity and difference between finite sample sets. The larger the Jaccard coefficient is, the higher the sample similarity is. Specifically, given two sets A, B, the Jaccard coefficient is defined as a ratio of the size of the intersection set of A and B to the size of the union set of A and B, defined as follows:

$$J ( A , B ) = \frac{\vert A ⋂ B \vert}{\vert A ⋃ B \vert} = \frac{\vert A ⋂ B \vert}{\vert A \vert + \vert B \vert - \vert A ⋂ B \vert} \qquad ( 1 )$$

When it is used to judge the similarity of two routes, the ratio of intersection set and union set of ports passed by the two routes is calculated according to above formula, and then the similarity of the two routes is calculated. The routes whose similarity is greater than 0.7 are considered as similar.

The route information extraction and classification step: in order to avoid a problem that the found routes are duplicated due to different sorting of ports in the DFS loop finding process, it is necessary to remove the duplication of the found route results. Routes that pass through the same ports in a different order are removed. And according to the information of the ports through which the route passes, the information of the countries and regions through which the route passes, the start and end time of the route, the operation entity of the route, the direction of the route and the port of the start and end of the route is extracted. The results are shown in Table 3, which shows information about the routes of the container ship with MMSI of 477776200 (only the top 10 results are shown here). And the routes are classified.

TABLE 3

| | route port | start time | end time | mmsi | region | region code |
|---|---|---|---|---|---|---|
| 0 | Singapore Jebel Ali Khalifa Dammam Singapore | [symbol] | [symbol] | [symbol] | [West Asia, | [symbol] |
| | | | | | Southeast Asia] | |
| 1 | Singapore Cai Mep China Hong Kong Yantian | [symbol] | [symbol] | [symbol] | [East Asia, | [symbol] |
| | Shanghai-Yangshan | | | | Southeast Asia] | |
| 2 | Shanghai-Yangshan Qingdao Shanghai- | [symbol] | [symbol] | [symbol] | [East Asia] | [symbol] |
| | Yangshan | | | | | |
| 3 | Shanghai-Yangshan Ningbo Prince Rupert Los Angeles | [symbol] | [symbol] | [symbol] | [East Asia, | [symbol] |
| | Oakland Tianjin Qingdao Shanghai-Yangshan | | | | West of North | |
| | | | | | America] | |
| 4 | Shanghai-Yangshan Prince Rupert Long Beach | [symbol] | [symbol] | [symbol] | [East Asia, | [symbol] |
| | Oakland Tianjin Qingdao Shanghai-Yangshan | | | | West of North | |
| | | | | | America] | |
| 5 | Shanghai-Yangshan Prince Rupert Los Angeles | [symbol] | [symbol] | [symbol] | [East Asia, | [symbol] |
| | Tianjin Qingdao Shanghai-Yangshan | | | | West of North | |
| | | | | | America] | |
| 6 | Shanghai-Yangshan Prince Rupert Los Angeles | [symbol] | [symbol] | [symbol] | [East Asia, | [symbol] |
| | Oakland Tianjin Qingdao Shanghai-Yangshan | | | | West of North | |
| | | | | | America] | |
| 7 | Shanghai-Yangshan Prince Rupert Los Angeles | [symbol] | [symbol] | [symbol] | [East Asia, | [symbol] |
| | Oakland Tianjin Qingdao Shanghai-Yangshan | | | | West of North | |
| | | | | | America] | |
| 8 | Shanghai-Yangshan Prince Rupert Los Angeles | [symbol] | [symbol] | [symbol] | [East Asia, | [symbol] |
| | Oakland Tianjin Qingdao Shanghai-Yangshan | | | | West of North | |
| | | | | | America] | |
| 9 | Shanghai-Yangshan Prince Rupert Los Angeles | [symbol] | [symbol] | [symbol] | [East Asia, | [symbol] |
| | Oakland Tianjin Qingdao Shanghai-Yangshan | | | | West of North | |
| | | | | | America] | |

| | | | domestic | operating | course | [symbol] eparture | destination |
|---|---|---|---|---|---|---|---|
| | country | country code | region | entity | direction | port | port |
| 0 | [Singapore, Saudi Arabia, | [symbol] | [symbol] | COSCO | east-west | Singapore | Dammam |
| | The United Arab Emirates] | | | SHIPPING | | | |
| 1 | [Singapore, China Hong Kong, | [symbol] | [East China, | COSCO | north-south | Yantian | Singapore |
| | China, Vietnam] | | South China] | SHIPPING | | | |
| 2 | [China] | [symbol] | [East China] | COSCO | north-south | Shanghai- | Shanghai- |
| | | | | SHIPPING | | Yangshan | Yangshan |
| 3 | [USA, Canada, China] | [symbol] | [East China, | COSCO | east-west | Shanghai- | Oakland |
| | | | North China] | SHIPPING | | Yangshan | |
| 4 | [USA, Canada, China] | [symbol] | [East China, | COSCO | east-west | Shanghai- | Oakland |
| | | | North China] | SHIPPING | | Yangshan | |
| 5 | [USA, Canada, China] | [symbol] | [East China, | COSCO | east-west | Shanghai- | Los Angeles |
| | | | North China] | SHIPPING | | Yangshan | |
| 6 | [USA, Canada, China] | [symbol] | [East China, | COSCO | east-west | Shanghai- | Oakland |
| | | | North China] | SHIPPING | | Yangshan | |
| 7 | [USA, Canada, China] | [symbol] | [East China, | COSCO | east-west | Shanghai- | Oakland |
| | | | North China] | SHIPPING | | Yangshan | |
| 8 | [USA, Canada, China] | [symbol] | [East China, | COSCO | east-west | Shanghai- | Oakland |
| | | | North China] | SHIPPING | | Yangshan | |
| 9 | [USA, Canada, China] | [symbol] | [East China; | COSCO | east-west | Shanghai- | Oakland |
| | | | North China] | SHIPPING | | Yangshan | |

[symbol]

indicates data missing or illegible when filed

Specifically, extraction of route information includes:
(1) Matching the routes to the corresponding countries and regions according to the information of the ports through which the routes passes;
(2) Finding out the start and end times of the routes, and determining relevant year and time information of the operation of the routes;
(3) According to the MMSI of the ship, finding out the operation entities of the ship and the routes;
(4) Naming the routes with specific codes according to the countries and regions through which the routes pass. It can be seen from Table 3 that the routes mainly pass through East Asia and the East of North America, so they are named ANA_E, wherein A represents Asia and NA_E represents the East of North America. And it's stored in a database. Routes that pass through the same region and country are considered one route. Routes through China are additionally divided into sub-routes based on North China, East China, South China, and other domestic regions.
(5) Determining the direction of the route, that adopts the Haversine formula to first calculate the distances between the ports through which the route passes in two relative directions, and then determines the direction of the route.
(6) Determining whether the direction of the route is east-west or north-south by comparing the distances between the ports through which the route passes in two relative directions (such as east-west and north-south).

Specifically, the longitude and latitude coordinates of the ports are extracted from the database. Using the Haversine formula, the spherical distance between two points can be solved by longitude and latitude, according to following formula:

$$( 2 )$$

$$d = 2 r arg sin ( \sqrt{{sin}^{2} ( \frac{lat 2 - lat 1}{2} ) + cos ( lat 2 ) cos ( lat 1 ) {sin}^{2} ( \frac{lon 2 - lon 1}{2} ) )}$$

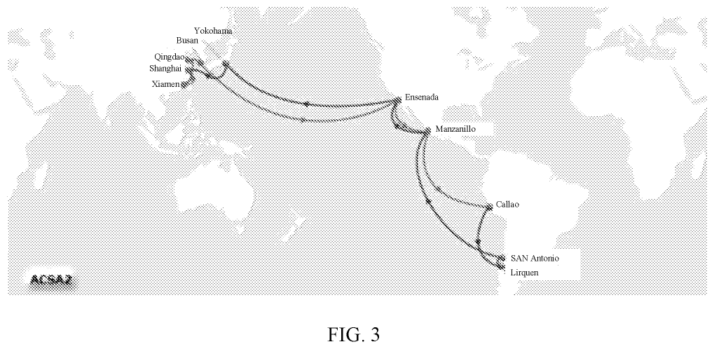

In the formula, lat1, lon1, lat2 and lon2 are the latitude and longitude coordinates of the two points respectively, r is the radius of the Earth, and its average value can be taken as 6371 km during calculation.
(7) Determining the start and end of the route by referring to the definitions of internationally renowned shipping companies, such as Maersk and CMA CGM, as shown in the Asia-South America Line (SCSA2) shipping routes map shown in FIG. 3. According to the regions through which the route passes, in the east-west route, a first port in the most east region and a first port in the most west region are taken as the starting point and the ending point respectively. In the north-south route, a first port in the most south region and a first port in the most north region are taken as the starting point and the end point respectively.

The classification of routes is based on the routes of major global container liners, comprising trans-Pacific routes (Far East-North America routes), trans-Atlantic routes (North America-Europe, Mediterranean routes), European routes, Mediterranean-Far East routes, Far East regional routes, Far East-Australia and New Zealand routes, Mediterranean-West Africa routes and South African routes.

The route transport capacity analysis step: according to the classified routes, transport capacity statistics, transport capacity change analysis and transport capacity monitoring of container ship routes passing through any two ports can be carried out, thus providing data basis for the comparison of operating efficiency of various shipping companies and data support for the development of new routes. The results of the route are saved in the database for subsequent calls.

The invention also relates to a system for analyzing the transport capacity of container liner routes. The system corresponds to the method for analyzing the transport capacity of container liner routes mentioned above, and can be understood as the system to realize above method. The system comprises successively connected a data collection module, a route identification module, a route processing module, a route information extraction and classification module and a route transport capacity analysis module, wherein,

The data collection module is used for collecting and further pre-processing the AIS historical navigation data and port data of container liners. Preferably, the historical navigation data includes static data and dynamic data. The static data includes Maritime Mobile Service Identify (MMSI), ship type, call sign, ship name, ship height, ship length and ship width. The dynamic data includes ship longitude and latitude position information, time stamp, course over ground, speed over ground and bow direction. Preferably, the port data includes the start and end times of each shipping segment and the ports of origin and end, the countries and regions to which the ports belong, and the longitudes and latitudes of the ports.

The route identification module for, based on the pre-processed data, by taking ports as nodes and container liner's shipping segments between ports as edges, drawing a directed graph of the liner's shipping route between or among ports for a single container liner; finding out all loops in the directed graph by using a depth-first search algorithm to identify the circular container liner routes;
the route processing module: matching the found loops with the historical navigation data so that only the loops that can be matched are retained, finding departure and end times of each route, removing data with overlapping times, and then finding similar routes that appear at least twice in succession and saving the routes as the identified routes;
the route information extraction and classification module for removing duplication of the found route results by removing the routes passing through the same ports but in different order, for extracting the information of the countries and regions through which the route passes, the start and end time of the route, the operation entity of the route, the direction of the route and the port of the start and end of the route according to the information of the ports through which the route passes, and for classifying the routes;
the route transport capacity analysis module for, according to the classified routes, carrying out transport capacity statistics, transport capacity change analysis and transport capacity monitoring of container ship routes passing through any two ports, thus providing data basis for comparison of operating efficiency of various shipping companies and data support for development of new routes, and saving the results of the route in the database for subsequent calls.

The present invention provides an objective and scientific method and system for analyzing the transport capacity of container liner routes. The invention realizes the identification and naming of global container liner routes by using the depth-first search algorithm, combining the AIS historical navigation data of container ships and actual service characteristics. In addition, the relevant information of the route is sorted out according to the ports through which the route passes, and then the transport capacity analysis and monitoring of the global container route are carried out, which defines a unified standard for all container liner routes, provides support for the transport capacity planning based on big data, and provides support for the transport capacity statistics and monitoring of sub-routes. At the same time, the ship type information of each route is retained, which is convenient for follow-up dynamic query of the route, transport capacity and ship type between any two ports.

It should be noted that above-described embodiments may make those skilled in the art more fully understand the invention, but do not limit the invention in any way. Therefore, although the present specification has been described in detail with reference to the accompanying drawings and embodiments, it should be understood by those skilled in the art that the invention can still be modified or equivalently replaced. In short, all technical solutions and improvements that do not deviate from the spirit and scope of the present invention shall all be covered by protection scope of the present patent.

1. A method for analyzing transport capacity of container liner routes, comprising following steps:
a data collection step: collecting AIS historical navigation data and port data of container liners;
a route identification step: based on collected data, by taking ports as nodes and container liner's shipping segments between ports as edges, drawing a directed graph of the liner's shipping route between or among ports for a single container liner; searching for all loops in the directed graph by using a depth-first search algorithm to identify the container liner routes;
a route processing step: matching the loops with the historical navigation data so that only the loops that can be matched are retained, finding departure time and end time of each route, removing data with overlapping times, and then finding similar routes that appear at least twice in succession and saving the routes as identified routes;
a route information extraction and classification step: removing duplication of found route results, extracting, according to information of the ports through which the route passes, information of countries and regions through which the route passes, start and end time of the route, operation entity of the route, direction of the route and ports of the start and end of the route, and classifying the routes;
a route transport capacity analysis step: according to classified routes, carrying out transport capacity statistics and transport capacity change analysis of container ship routes passing through any two ports to obtain results of the transport capacity statistics and transport capacity change analysis of the routes, thus providing data basis for comparison of operating efficiency of various shipping companies and data support for development of new routes.

2. The method for analyzing transport capacity of container liner routes according to claim 1, wherein the data collection step, the AIS historical navigation data includes static data and dynamic data, the static data includes Maritime Mobile Service Identify, ship type, call sign, ship name, ship height, ship length and ship width, the dynamic data includes ship longitude and latitude position information, time stamp, course over ground, speed over ground and bow direction.

3. The method for analyzing transport capacity of container liner routes according to claim 2, wherein the data collection step, the port data includes start and end times of each shipping segment and the ports of origin and end, the countries and regions to which the ports belong, and the longitudes and latitudes of the ports.

4. The method for analyzing transport capacity of container liner routes according to claim 1, wherein the data collection step, first of all, pre-processing the AIS historical navigation data to remove problematic data in the AIS, and then pre-processing the port data to remove data related to ship repair, data where the port of origin and port of destination are missing, data related to unknown ports, and data where the port of origin and port of destination are the same, matching the ports of origin and ports of destination to corresponding countries and regions respectively.

5. The method for analyzing transport capacity of container liner routes according to claim 1, wherein the route identification step, the depth-first search algorithm is adopted to carry out depth-first search with each port as starting point, duplicate paths in search results are removed, and then all loops in the directed graph are found.

6. The method for analyzing transport capacity of container liner routes according to claim 1, wherein the route processing step, using Jaccard similarity coefficient to calculate similarity between two routes, and then the similar routes are determined.

7. The method for analyzing transport capacity of container liner routes according to claim 1, wherein the route processing step, according to the historical navigation data of container liners, the parts that do not form loops are found by combining service logic, these parts, together with matched loops, are sorted according to the departure time and end time of each route to ensure integrity of historical navigation dynamics.

8. The method for analyzing transport capacity of container liner routes according to claim 1, wherein the route information extraction and classification step, a Haversine formula is adopted to first calculate a distance between the ports through which the route passes in two relative directions, and then determines the direction of the route.

9. A system for analyzing transport capacity of container liner routes, comprising a data collection module, a route identification module, a route processing module, a route information extraction and classification module and a route transport capacity analysis module,
the data collection module is used for collecting AIS historical navigation data and port data of container liners;
the route identification module is used for, based on collected data, by taking ports as nodes and container liner's shipping segments between ports as edges, drawing a directed graph of the liner's shipping route between or among ports for a single container liner; searching for all loops in the directed graph by using a depth-first search algorithm to identify circular container liner routes;
the route processing module is used for matching the loops with the historical navigation data so that only the loops that can be matched are retained, finding departure time and end time of each route, removing data with overlapping times, and then finding similar routes that appear at least twice in succession and saving the routes as identified routes;
the route information extraction and classification module is used for removing duplication of found route results, for extracting information of countries and regions through which the route passes, start and end time of the route, operation entity of the route, direction of the route and ports of the start and end of the route according to information of the ports through which the route passes, and for classifying the routes;
the route transport capacity analysis module is used for, according to classified routes, carrying out transport capacity statistics and transport capacity change analysis of container ship routes passing through any two ports to obtain results of the transport capacity statistics and transport capacity change analysis of the routes, thus providing data basis for comparison of operating efficiency of various shipping companies and data support for development of new routes.

10. The system for analyzing transport capacity of container liner routes according to claim 9, wherein the AIS historical navigation data includes static data and dynamic data, the static data includes Maritime Mobile Service Identify, ship type, call sign, ship name, ship height, ship length and ship width, the dynamic data includes ship longitude and latitude position information, time stamp, course over ground, speed over ground and bow direction; the port data includes start and end times of each shipping segment and the ports of origin and end, the countries and regions to which the ports belong, and the longitudes and latitudes of the ports;
and/or, wherein the route identification module, the depth-first search algorithm is adopted to carry out depth-first search with each port as starting point, duplicate paths in search results are removed, and then all loops in the directed graph are found.
